(19) United States
(12) Patent Application Publication
(10) Pub. No.: US 2016/0279876 A1
(43) Pub. Date: Sep. 29, 2016

(54) TEMPERATURE-RESPONSIVE ILLUMINATION ARTICLE AND METHOD FOR IMPLEMENTING SAME

(71) Applicant: Pragmatic Designs Inc., Sandy Hook, CT (US)

(72) Inventor: Julia D. Truchsess, Sandy Hook, CT (US)

(73) Assignee: Pragmatic Designs Inc., Sandy Hook, CT (US)

(21) Appl. No.: 15/078,405

(22) Filed: Mar. 23, 2016

Related U.S. Application Data
(60) Provisional application No. 62/137,301, filed on Mar. 24, 2015.

(51) Int. Cl. B29C 67/00; G01K 11/12

(52) U.S. Cl. CPC B29C 67/0085; B29C 67/0055; G01K 11/12; B29K 2105/0058

(57) ABSTRACT

Embodiments of the disclosure are directed to a temperature-responsive illumination apparatus for a 3-D printer. The illumination apparatus includes a temperature sensor that measures the temperature of an extrusion nozzle of the 3-D printer and generates a first parameter indicative of the measured temperature. The illumination apparatus further includes a controller circuitry that selects a color representing the measured temperature from a plurality of colors and transmits at least one control parameter based on the selected color. Each of the plurality of colors represents a fixed range of temperatures. The illumination apparatus also includes an illumination source configured to emit light of the selected color indicative of the measured temperature based on the at least one control parameter.

### CROSS-REFERENCE TO RELATED APPLICATIONS

The present patent application claims the benefit of priority under 35 U.S.C. §120 to U.S. Provisional Application No. 62/137,301, filed on Mar. 24, 2015, the entirety of which is incorporated herein by reference.

### TECHNICAL FIELD

Embodiments of the present disclosure relate to three-dimensional (3-D) printers and 3-D printing methods, and more particularly, to 3-D printers and 3-D printing methods that use a heated extruder to melt a solid raw material for extrusion.

### BACKGROUND

Apart from their utility, 3-D printers are used to make three-dimensional objects for prototypes or display purposes and are fascinating and entertaining machines to watch during operation. Existing 3-D printers, however, provide little visual display beyond their mechanical operation, work area functional illumination, and alphanumerical displays of operating parameters and status.

In a typical thermal extrusion-based 3-D printer, a temperature sensing element is positioned in intimate physical contact with the 3-D printer's extrusion nozzle in order to accurately measure the nozzle's temperature for correct extrusion. The temperature sensor is connected to suitable signal-conditioning electronic circuitry, which produces an output that is then digitized by an analog-to-digital converter for use by firmware. The firmware runs on the 3-D printer's microcontroller to control the extruder's temperature via a heating element located in the extruder. If the temperature of the nozzle is too low, the material to be extruded will not flow as easily and the quality of the 3-D printed object can be adversely affected. Similarly, if the temperature of the nozzle is too high, the material to be extruded will flow too easily and the quality of the 3-D printed object can also be adversely affected. Thus, the temperature of the extrusion nozzle needs to be monitored during the 3-D printing process and be controlled in a precise manner.

Unfortunately, however, some current 3-D printers only have a computer screen to output and inform an operator of the nozzle temperature. This temperature information can be difficult to see unless the reader is right in front of the screen. This is undesirable because, depending upon the complexity of the desired print out, it can take hours or days for the 3-D printer to create a 3-D object or a print out. During this time period, an operator of the 3-D printer may leave or move about the room to work on other projects. If the operator forgets to keep checking the nozzle temperature on the computer screen, the entire job may have to be reprinted, which may result in hundreds of hours of lost time. Other 3-D printers may have a color display, such as a ring shaped LCD display, that indicates whether some parts of the printer are close to their assigned temperatures within certain degrees. For example, when the temperature of the extrusion nozzle is at a set point of 210° C., the color of the LCD display is green. When the temperature of the extrusion nozzle is below or above the set point, the color of the LCD display is red. Nonetheless, the color LCD display of these 3-D printers does not suggest the various temperatures of the extrusion nozzle during the 3-D printing process.

Accordingly, there exists a need for methods and apparatuses to improve the 3-D printing process or 3-D printers to monitor and control the temperature of the extrusion nozzle.

### SUMMARY

Embodiments of the present disclosure are directed to methods and apparatuses for temperature-responsive illumination source that is incorporated with a 3-D printer for visually indicating the temperature of the extrusion nozzle. A control means for controlling the color emitted by the illumination source responsive to the temperature of the extrusion nozzle is provided, wherein the control means controls and varies the color produced and emitted by the illumination source according to the value of temperature signal generated by a temperature sensor associated with the extruder. Various embodiments of the disclosure may include one or more of the following aspects.

In accordance with one embodiment, a temperature-responsive illumination apparatus for a 3-D printer may include a temperature sensor that measures the temperature of an extrusion nozzle of the 3-D printer and generates a first parameter indicative of the measured temperature. The illumination apparatus may also include a controller circuitry that selects a color representing the measured temperature from a plurality of colors and transmits at least one control parameter based on the selected color. Each of the plurality of colors may represent a fixed range of temperatures. The illumination apparatus may further include an illumination source configured to emit light of the selected color indicative of the measured temperature based on the at least one control parameter.

Various embodiments of the apparatus may include one or more of the following features: the controller circuitry may determine the selected color based on a look-up table and the first parameter; the look-up table may include a one-to-one mapping relationship between the plurality of colors and a plurality of fixed temperatures and/or fixed ranges of temperatures; the controller circuitry may select the color from the plurality of colors based on a predetermined function of the first parameter; the illumination source may be installed on an extruder assembly and moves with the extruder assembly during a 3-D printing process; the illumination source may be installed on a stationary object of the 3-D printer; the illumination source may be retrofit to the 3-D printer by connecting the illumination source with the temperature sensor via an electronic circuitry; the illumination source may include at least three LEDs configured to emit light of one or more colors, and the selected color corresponds to an overall output color of the LEDs; the illumination apparatus may further include a signal-conditioning circuitry that converts a temperature-dependent parameter generated by the temperature sensor into the first parameter.

In accordance with another embodiment, a method for temperature-responsive illumination for a 3-D printer may include measuring the temperature of an extrusion nozzle of the 3-D printer and generating a first parameter indicative of the measured temperature by a temperature sensor. The method may also include selecting a color representing the measured temperature from a plurality of colors and transmitting at least one control parameter based on the selected color by a controller circuitry. Each of the plurality of colors may represent a fixed range of temperatures. The method may further include emitting light of the selected color indicative of the measured temperature based on the at least one control parameter by an illumination source.

Various embodiments of the method may include one or more of the following features: the method may further include determining the selected color based on a look-up table and the first parameter by the controller circuitry; the look-up table may include a one-to-one mapping relationship between the plurality of colors and a plurality of fixed temperatures and/or fixed ranges of temperatures; the method may further include selecting the color from the plurality of colors based on a predetermined function of the first parameter; the illumination source may be installed on an extruder assembly and moves with the extruder assembly during a 3-D printing process; the illumination source may be installed on a stationary object of the 3-D printer; the illumination source may be retrofit to the 3-D printer by connecting the illumination source with the temperature sensor via an electronic circuitry; the illumination source may include at least three LEDs configured to emit light of one or more colors, and the selected color corresponds to an overall output color of the LEDs; the method may further include converting a temperature-dependent parameter generated by the temperature sensor into the first parameter by a signal-conditioning circuitry.

In accordance with another embodiment, 3-D printing system may include an extrusion nozzle for extruding at least one printing material. The 3-D printing system may include a temperature sensor that measures the temperature of the extrusion nozzle and generates a first parameter indicative of the measured temperature. The 3-D printing system may also include a controller circuitry that selects a color representing the measured temperature from a plurality of colors and transmits at least one control parameter based on the selected color. Each of the plurality of colors represents a fixed range of temperatures. The 3-D printing system may further include an illumination source configured to emit light of the selected color indicative of the measured temperature based on the at least one control parameter.

The details of one or more variations of the present disclosure are set forth below and the accompanying drawings. Other features and advantages of the present disclosure will be apparent from the detailed description below and drawings, and from the claims.

Further modifications and alternative embodiments will be apparent to those of ordinary skill in the art in view of the present disclosure. For example, the methods, apparatuses, and systems may include additional components or steps that are omitted from the diagrams and description for clarity of operation. Accordingly, the detailed description below is to be construed as illustrative only and is for the purpose of teaching those skilled in the art the general manner of carrying out the present disclosure. It is to be understood that the various embodiments disclosed herein are to be taken as exemplary. Elements and materials, and arrangements of those elements and materials, may be substituted for those illustrated and disclosed herein, parts and processes may be reversed, and certain features of the present disclosure may be utilized independently, all as would be apparent to one skilled in the art after having the benefit of the disclosure herein. Changes may be made in the embodiments disclosed herein without departing from the spirit and scope of the present disclosure and the claims.

### BRIEF DESCRIPTION OF THE DRAWINGS

The accompanying drawings, which are incorporated in and constitute a part of this specification, illustrate exemplary embodiments of the present disclosure, and together with the description, serve to explain the principles of the disclosure.

FIG. 1 illustrates a perspective view of an exemplary 3-D printer having a temperature-responsive illumination source, in accordance with embodiments of the present disclosure.

FIG. 2 shows an exemplary extruder for use with the 3-D printer of FIG. 1.

FIG. 3 depicts a chart illustrating exemplary relationships between colors and temperatures, in accordance with embodiments of the present disclosure.

FIG. 4 depicts a schematic block diagram illustrating an exemplary temperature sensor and associated circuitry for controlling the temperature-responsive illumination source of the 3-D printer of FIG. 1, in accordance with embodiments of the present disclosure.

FIG. 5 depicts a schematic block diagram illustrating an exemplary temperature sensor and associated circuitry for controlling the temperature-responsive illumination source of the 3-D printer of FIG. 1, in accordance with embodiments of the present disclosure.

FIG. 6 illustrates a perspective view of an exemplary 3-D printer having a temperature-responsive illumination source, in accordance with embodiments of the present disclosure.

FIG. 7 depicts a flowchart illustrating an exemplary method for implementing temperature-responsive illumination for the 3-D printers of FIG. 1 and FIG. 6, in accordance with embodiments of the present disclosure.

### DETAILED DESCRIPTION

This description and the accompanying drawings that illustrate exemplary embodiments should not be taken as limiting. Various mechanical, compositional, structural, electrical, and operational changes may be made without departing from the scope of this description and the claims, including equivalents. In some instances, well-known structures and techniques have not been shown or described in detail so as not to obscure the disclosure. Similar reference numbers in two or more figures represent the same or similar elements. Furthermore, elements and their associated features that are disclosed in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Those having ordinary skill in the art and access to the teachings provided herein will recognize additional modifications, applications, embodiments, and substitution of equivalents that all fall with the scope of the present disclosure.

The present disclosure discloses a system, such as a 3-D printer, that includes an illumination source configured to emit different colors in response to the temperature of the extrusion nozzle. The present disclosure advantageously allows the temperature of the nozzle to be determined by looking at the color of the light emitted by the illumination source. Additionally, because the illumination source may be connected to the printer head and thus, may be moving, the illumination source may be used for entertainment during the printing process.

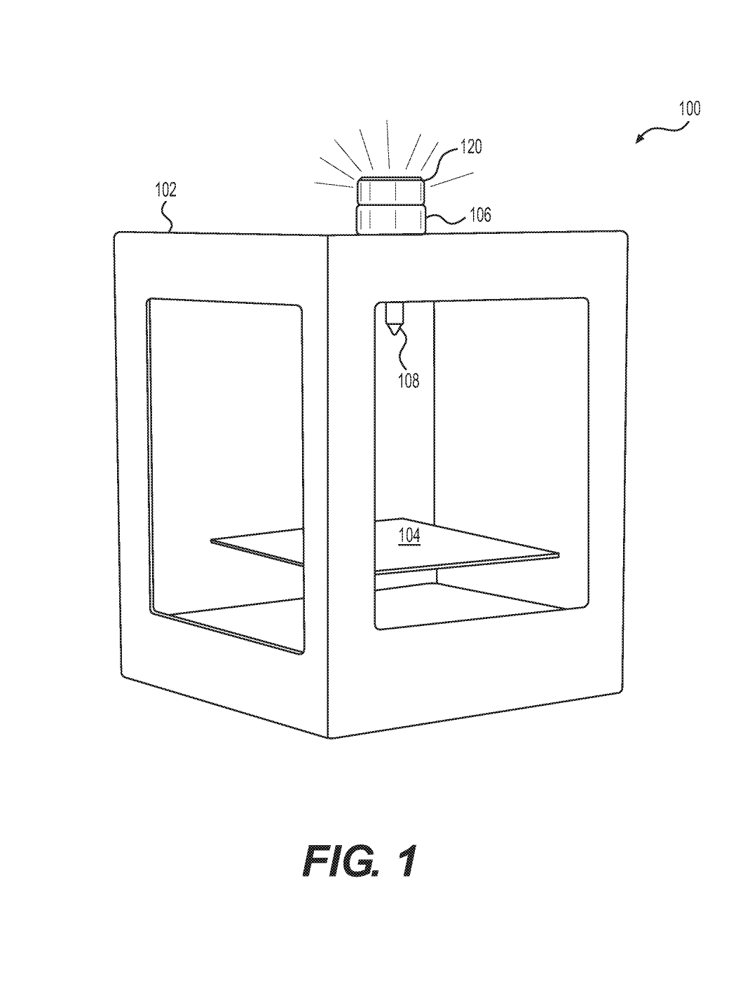

FIG. 1 illustrates a perspective view of an exemplary 3-D printer 100 having a temperature-responsive illumination source 120. As shown in FIG. 1, 3-D printer 100 includes a printer frame 102, a printer build surface 104, a printer head 106, and an extruder 108. Extruder 108 is connected to printer head 106. Printer head 106 is movably connected to printer frame 102 to move in one or more dimensions (e.g., 3-dimensions) distal and/or proximate printer build surface 104. Printer frame 102 and its walls are designed such that printer build surface 104 is visible and/or accessible from one or more angles, such as the sides, front, rear, and/or top of 3-D printer 100. Light emitted by illumination source 120 is at least partially visible from outside of 3-D printer 100.

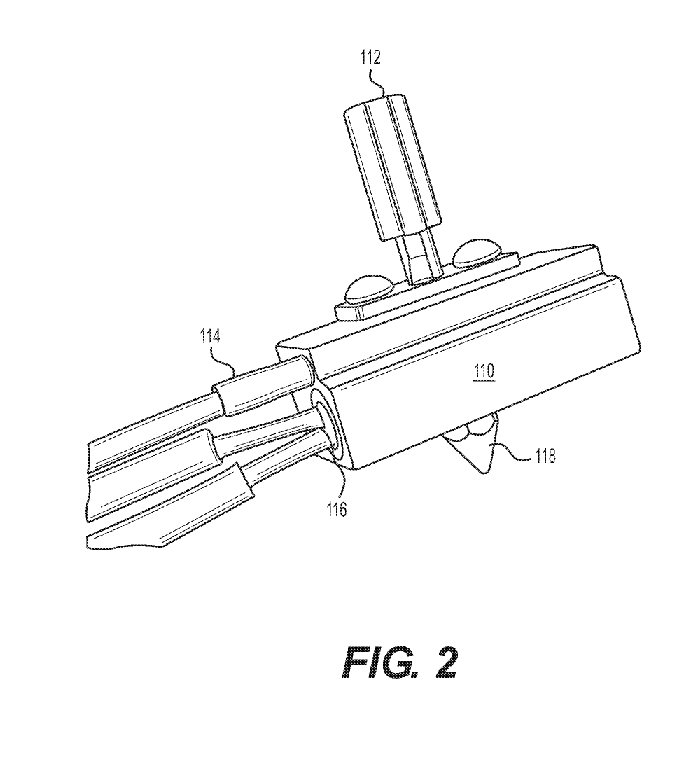

FIG. 2 shows an exemplary extruder or extruder assembly 108 for use with 3-D printer 100 of FIG. 1. As shown in FIG. 2, extruder 108 includes a heat block 110, a material inlet 112, e.g., a plastic filament inlet, a temperature sensor 114, a heating element 116, and an extrusion outlet (nozzle) 118, for deposition of extrusion material onto printer build surface 104. Temperature sensor 114 is mounted to extruder 108, and may be mounted at a position in intimate physical contact with heat block 110 and/or extrusion nozzle 118, for example. Heating element 116 may be embedded in a block of metal of extruder 108, e.g., heat block 110. Extrusion nozzle 118 may be made of a heat-conducting material, such as copper or brass that may be heated to 250° C. or above.

Typically, an extruder for a 3-D printer operates by receiving an extrusion material into the extruder via a material inlet. Extruder 108 may include various tubes or channels for guiding the extrusion material to and/or through extrusion nozzle 118. Extruder 108 may further include a motor for pushing extrusion materials, e.g., plastic filament, to and/or through extrusion nozzle 118. In some embodiments, the motor is located remotely from extruder 108 and the extrusion material is pushed through a long plastic tube to extruder 108. For example, extruder 108 receives the extrusion material via material inlet 112, and the extrusion material is directed through heat block 110 where extrusion nozzle 118 is heated to a desired temperature. This desired temperature is achieved by heating element 116, which is in contact with or in proximity to extrusion nozzle 118 at least partially located in heat block 110. The temperature of extrusion nozzle 118 is measured and/or monitored by temperature sensor 114. When extrusion nozzle 118 reaches a desired temperature, the extrusion material is caused to flow out of extrusion nozzle 118 in a controlled manner to deposit extrusion material onto printer build surface 104, thereby creating a 3-D product or a “print out.”

As described above, 3-D printer 100 includes temperature-responsive illumination source 120 associated with printer head 106 such that when printer head 106 moves in any one of the multiple dimensions, illumination source 120 also moves in that dimension. Furthermore, illumination source 120 may be a multi-color illumination source, such as an RGB LED assembly, which may include red, green, and blue LEDs arranged such that their luminous emission can be combined in various proportions under software control to produce a wide variety of desired colors of illumination.

The color of the emitted light of illumination source 120 is configured to be responsive, at least in part, to the temperature of extrusion nozzle 118 measured by temperature sensor 114. A controller circuitry may be used to determine a general relationship that maps low temperatures to cold colors, such as blue or green colors, and maps high temperatures to warm or hot colors, such as orange or red colors. The colors and mapping relationship may be hardcoded or pre-stored in the controller circuitry.

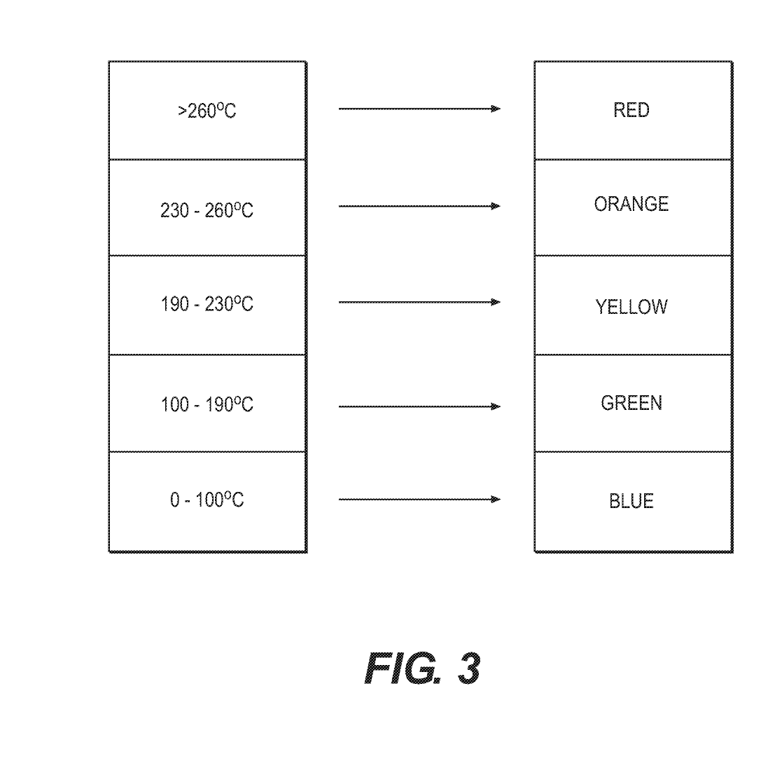

The colors of illumination source 120 may produce a pleasing and intuitive color display for the user. For example, FIG. 3 depicts a chart illustrating exemplary relationships between colors and temperatures. As shown in FIG. 3, if the measured temperature of extrusion nozzle 118 is between about 0° C. and about 100° C., illumination source 120 is configured to emit blue light; if the measured temperature of extrusion nozzle 118 is between about 100° C. and about 190° C., the illumination source 120 is configured to emit green light; if the measured temperature of extrusion nozzle 118 is between about 190° C. and about 230° C., illumination source 120 is configured to emit yellow light; if the measured temperature of extrusion nozzle 118 is between about 230° C. and about 260° C., illumination source 120 is configured to emit orange light; and if the measured temperature of extrusion nozzle 118 is greater than about 260° C., illumination source 120 is configured to emit red light. As described herein, the above temperature ranges are exemplary only, and other suitable relationships between colors of light from illumination source 120 and temperatures of extrusion nozzle 118 may be provided by 3-D printer 100 or may be determined by the operator of 3-D printer 100. In such situations, illumination source 120 functions as a thermometer with colored light as a visual indicator of the measured temperature of extrusion nozzle 118.

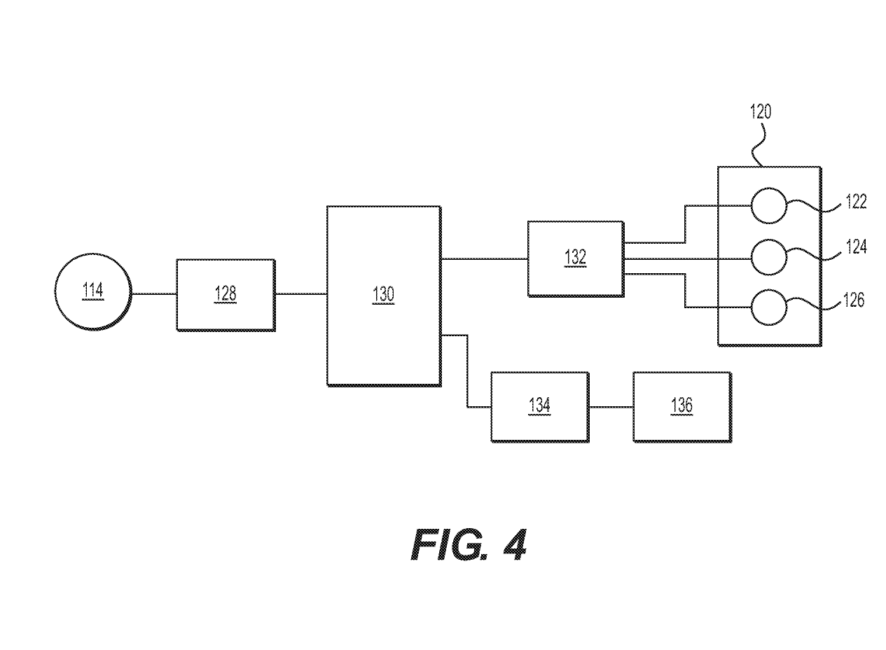

FIG. 4 depicts a schematic block diagram illustrating an exemplary temperature sensor 114 and associated electronic circuitry for controlling temperature-responsive illumination source 120. In some embodiments, the mapping of the measured temperature to the color of illumination source 120 may be derived by a controller circuitry 130 as shown in FIG. 4. Controller circuitry 130 may be a microcontroller. Controller circuitry 130 may, for example, adjust the color of illumination source 120 by using a numeric formulae to calculate one or more lighting control parameters. In other embodiments, for speed and simplicity, controller circuitry 130 may use look-up tables where temperature values are suitably quantized and used for indexing to an array of illumination intensity values for the color-emitting elements, e.g., LEDs, in illumination source 120. The look-up table may be fixedly stored in a storage circuitry of controller circuitry 130. In some embodiments, the color of illumination source 120 may undergo smooth or gradual transition upon changes of the measured temperature. Such smooth or gradual transition may create an aesthetical effect. The smooth or gradual transition may be achieved, for example, when the quantization of temperature values is sufficiently fine and/or the number of colors that can be generated by illumination source 120 is sufficiently large within a predetermined spectrum.

As shown in FIG. 4, the electronic circuitry may further include a suitable signal-conditioning electronic circuitry 128, a first driver circuitry 132, and/or a second driver circuitry 134. Signal-conditioning electronic circuitry 128 may connect to an electrical input of controller circuitry 130 and send an electrical signal, such as an analogue signal, to controller circuitry 130. First driver circuitry 132 may connect to an electrical output of controller circuitry 130 and receive an electrical signal from controller circuitry 130. In some embodiments, signal-conditioning electronic circuitry 128 may be a part of an internal circuitry of temperature sensor 114. First driver circuitry 132 may be a part of an internal circuitry of illumination source 120.

In some embodiments, controller circuitry 130 includes an analog-to-digital converter circuitry. In other embodiments, a separate analog-to-digital converter circuitry external to controller circuitry 130 may be used. Electrical signals from temperature sensor 114 and/or signal-conditioning electronic circuitry 128 are received and converted to digital data representing temperatures of extrusion nozzle 118, which can then be used by controller circuitry 130, for example, to generate electrical signals to send to first driver circuitry 132.

The design and composition of signal-conditioning electronic circuitry 128 depend on the type of temperature sensor 114 used. For example, a thermocouple produces a temperature-dependent voltage, which may then be amplified, linearized, and/or compensated for ambient temperature by signal-conditioning electronic circuitry 128. For another example, a thermistor or a resistance temperature detector (RTD) has a temperature-dependent resistance that may be measured and/or converted by signal-conditioning electronic circuitry 128. Other suitable temperature sensors and signal-conditioning electronic circuitry 128 may be used and interfaced with controller circuitry 130.

Controller circuitry 130 electrically connects to first driver circuitry 132, which electrically connects to illumination source 120. As described above, illumination source 120 may be a multi-color lighting element. In some embodiments, illumination source may include one or more red LEDs 122, green LEDs 124, and/or blue LEDs 126. A wide variety of desired colors of illumination may be produced by illumination source 120 by adjusting the luminous outputs of the different colored LEDs in various proportions and combining them. Controller circuitry 130 controls the color of the light being emitted from illumination source 120 based on the output of temperature sensor 114, e.g., an electrical signal received indicative of the temperature measured by temperature sensor 114. Thus, controller circuitry 130 receives the output of temperature sensor 114, and then adjusts the relative amounts of illumination produced by one or more of the red LEDs 122, green LEDs 124, and blue LEDs 126 respectively so that the overall luminous output corresponds with a predetermined temperature and/or temperature range. For example, controller circuitry 130 may adjust the amounts of illumination of the LEDs by adjusting the power, voltage, and/or current supplied to the LEDs respectively or via pulse-width modulation by first driver circuitry 132.

Second driver circuitry 134 may be connected to one or more electro-mechanical parts 136 of 3-D printer 100, such as heating element 108 and motors that controls the movement of printer head 106 and/or extruder 118.

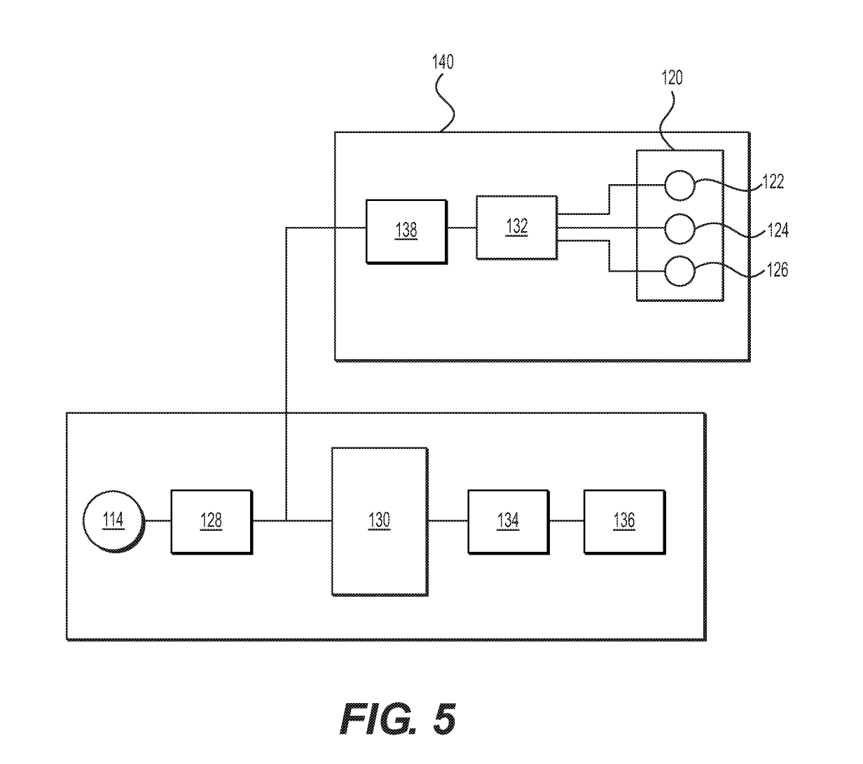

FIG. 5 depicts a schematic block diagram illustrating temperature sensor 114 and its associated circuitry for controlling temperature-responsive illumination source 120 as an accessory 140 for existing 3-D printers. The existing 3-D printers may not have illumination source 120 installed therein and/or may not have the temperature-responsive visual indication provided by illumination source 120 and its associated circuitry. Illumination source 120 of the present disclosure may be implemented, e.g., via retrofit, with existing 3-D printers, such as commercially available or custom-built 3-D printers, as desired. As shown in FIG. 5, an accessory assembly 140 for implementing illumination source 120 may be used. Accessory assembly 140 may include first driver circuitry 132 and a controller circuitry 138. Controller circuitry 138 may be referred to as a microcontroller 138. Accessory assembly 140 may electrically connect illumination source 120 to controller circuitry 130 and/or temperature sensor 114 of an existing 3-D printer. Microcontroller 138 may include an analog-to-digital converter circuitry whose analog input is connected to the output of signal-conditioning electronic circuitry 128 of temperature sensor 114. The input of microcontroller 138 may also be connected to the output of controller circuitry 130. Microcontroller 138 may further include an output connected to first driver circuitry 132 to control the overall output color of illumination source 120 as describe above.

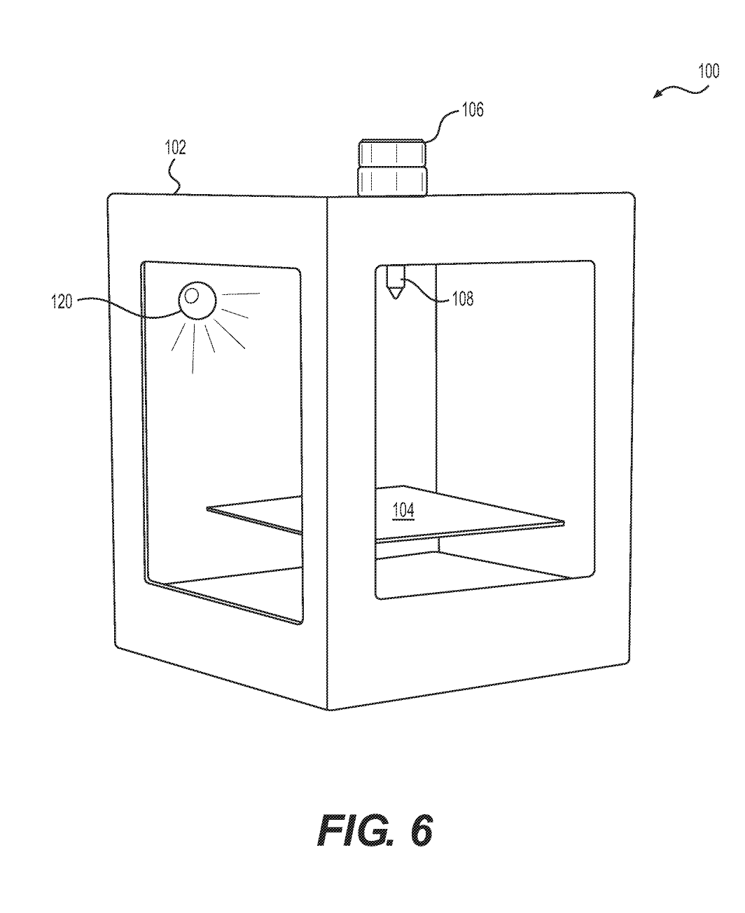

FIG. 6 illustrates a perspective view of 3-D printer 100 having temperature-responsive illumination source 120 installed on a stationary object. As shown in FIG. 6, 3-D printer 100 includes printer frame 102, printer build surface 104, printer head 106, and extruder 108. Extruder 108 is connected to printer head 106 and printer head 106 is movably connected to printer frame 102 to move in one or more dimensions (e.g., three-dimensions) proximate printer build surface 104. In some embodiments, as shown in FIG. 6, illumination source 120 is provided and connected to a stationary object, such as printer frame 102. In such instances, illumination source 120 may not move with printer head 106. Light emitted by illumination source 120 may penetrate printer frame 102 and/or irradiate the space and/or objects contained in printer frame 102, such as printer build surface 104, the object being printed, and/or extruder 108.

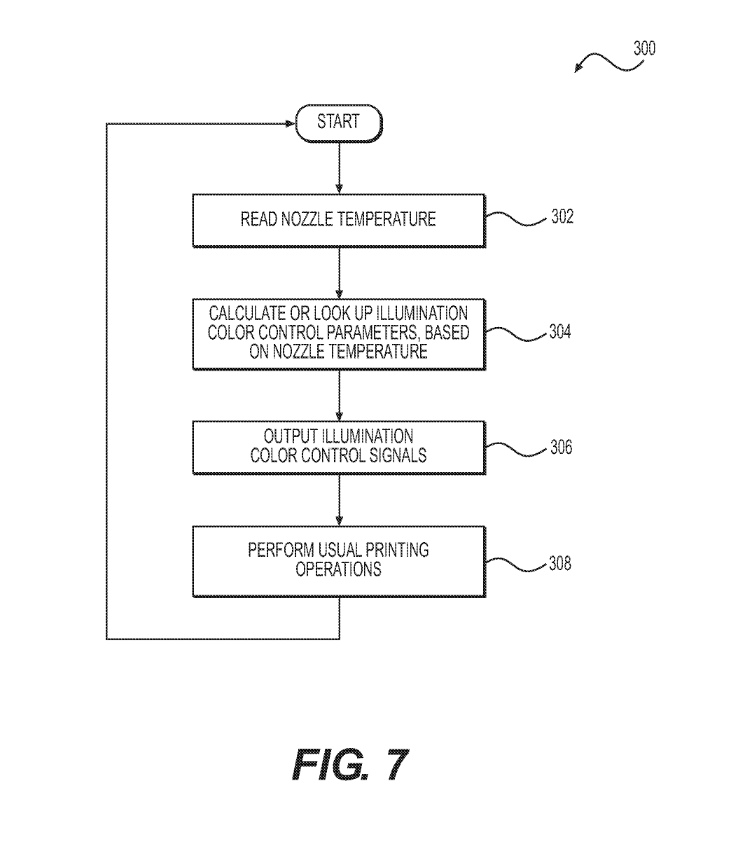

FIG. 7 depicts a flowchart illustrating an exemplary method 300 for implementing temperature-responsive illumination for 3-D printer 100 shown in FIGS. 1 and 6. As shown in FIG. 7, method 300 includes step 302 that reads, determines, measures, and/or detects the temperature of extrusion nozzle 118. Step 302 may be accomplished by temperature sensor 114, which is connected to or located adjacent to extrusion nozzle 118 such that temperature sensor 114 can sense or measure the temperature of extrusion nozzle 118. Step 302 may further include generating an electrical signal corresponding to the measured temperature by temperatures sensor 114 and/or signal-conditioning electronic circuitry 128. Method 300 further includes step 304 that determines what color of light the illumination source 120 should be emitting responsive to the temperature of the extrusion nozzle 118. As described herein, step 304 may be accomplished by receiving the electrical signal indicative of the measured temperature, and then calculating, e.g., by controller circuitry 130, which desired color of light should be emitted based on a predetermined algorithm and/or by referencing a look-up table that is stored in a non-transitory memory circuitry in controller circuitry 130 and has predetermined colors for predetermined temperature or temperature ranges. Step 304 may include sending electrical signals from controller circuitry 130 to first driver circuitry 132 to adjust the overall luminous output of illumination source 120 to the desired color. Method 300 further includes step 306 that operates illumination source 120 to emit light in the color determined in step 304, responsive to the temperature of extrusion nozzle 118. For example, step 306 may include adjusting the power, voltage, and/or current supplied to the LEDs respectively or via pulse-width modulation by first driver circuitry 132. Method 300 may further include step 308, which include one or more of the usual printing operations of 3-D printer 100. Step 308 may be performed at the same time, before, and/or after the other steps of method 300.

Method 300 of FIG. 7 may be implemented by a controller disposed internally in 3-D printer 100, such as controller circuitry 130, or a controller disposed external to 3-D printer 100. Additionally or alternatively, method 300 may be implemented by a controller operating in response to a computer program, which may be stored in a non-transitory computer-readable medium. In order to perform the described methods and steps, as well as the computations (e.g., execution of steps, control algorithm(s), the control processes prescribed herein, and the like), the controller may include, but not be limited to, a processor(s), computer(s), memory, storage, register(s), timing, interrupt(s), communication interface(s), and input/output signal interface(s), as well as any suitable combination comprising at least one of the foregoing.

The disclosure may be embodied in the form of a computer or controller implemented process. The disclosure may also be embodied in the form of computer program codes containing instructions embodied in tangible media, such as floppy diskettes, CD-ROMs, hard drives, and/or any other computer-readable medium. When the computer program code is loaded into and executed by a computer or controller, the computer or controller becomes an apparatus for practicing the disclosure. The disclosure can also be embodied in the form of computer program codes, for example, whether stored in a storage medium, loaded into and/or executed by a computer or controller, or transmitted over some transmission medium, such as over electrical wiring or cabling, through fiber optics, or via electromagnetic radiation, wherein when the computer program code is loaded into and executed by a computer or a controller, the computer or controller becomes an apparatus for practicing the disclosure. When implemented on a general-purpose microprocessor, the computer program code segments may configure the microprocessor to create specific logic circuits and/or execute predetermined steps.

While the disclosure has been described with reference to exemplary embodiments, it should be understood by those skilled in the art that various changes may be made and equivalents may be substituted for elements thereof without departing from the scope of the disclosure. Moreover, the embodiments or parts of the embodiments may be combined in whole or in part without departing from the scope of the disclosure. In addition, many modifications may be made to adapt a particular situation or material to the teachings of the disclosure without departing from the scope thereof. Therefore, it is intended that the disclosure not be limited to the particular embodiments disclosed herein, but that the disclosure will include all embodiments falling within the scope of the appended claims. Moreover, unless specifically stated any use of the terms first, second, etc. do not denote any order or importance, but rather the terms first, second, etc. are used to distinguish one element from another.

A temperature-responsive illumination source is provided and incorporated with a 3-D printer for visually indicating the temperature of an extrusion nozzle. Control means for controlling the color of the light emitted by the illumination source responsive to the temperature of the extrusion nozzle is provided. The control means controls and varies the color of the light emitted by the illumination source according to the value of a temperature signal generated by a temperature sensor associated with the extruder.

Those skilled in the art will appreciate that the conception upon which this disclosure is based may readily be used as a basis for designing other structures, methods, and systems for carrying out the several purposes of the present disclosure. Accordingly, the claims are not to be considered as limited by the foregoing description.

What is claimed is:

1. A temperature-responsive illumination apparatus for a 3-D printer, the apparatus comprising:
a temperature sensor that measures the temperature of an extrusion nozzle of the 3-D printer and generates a first parameter indicative of the measured temperature;
a controller circuitry that selects a color representing the measured temperature from a plurality of colors and transmits at least one control parameter based on the selected color, wherein each of the plurality of colors represents a fixed range of temperatures; and
an illumination source configured to emit light of the selected color indicative of the measured temperature based on the at least one control parameter.

2. The apparatus of claim 1, wherein the controller circuitry determines the selected color based on a look-up table and the first parameter.

3. The apparatus of claim 2, wherein the look-up table comprises a one-to-one mapping relationship between the plurality of colors and a plurality of fixed temperatures and/or fixed ranges of temperatures.

4. The apparatus of claim 1, wherein the controller circuitry selects the color from the plurality of colors based on a predetermined function of the first parameter.

5. The apparatus of claim 1, wherein the illumination source is installed on an extruder assembly and moves with the extruder assembly during a 3-D printing process.

6. The apparatus of claim 1, wherein the illumination source is installed on a stationary object of the 3-D printer.

7. The apparatus of claim 1, wherein the illumination source can be retrofit to the 3-D printer by connecting the illumination source with the temperature sensor via an electronic circuitry.

8. The apparatus of claim 1, wherein the illumination source includes at least three LEDs configured to emit light of one or more colors, and the selected color corresponds to an overall output color of the LEDs.

9. The apparatus of claim 1, further comprising a signal-conditioning circuitry that converts a temperature-dependent parameter generated by the temperature sensor into the first parameter.

10. A method for temperature-responsive illumination for a 3-D printer, the method comprising:
measuring the temperature of an extrusion nozzle of the 3-D printer and generating a first parameter indicative of the measured temperature by a temperature sensor;
selecting a color representing the measured temperature from a plurality of colors and transmitting at least one control parameter based on the selected color by a controller circuitry, wherein each of the plurality of colors represents a fixed range of temperatures; and
emitting light of the selected color indicative of the measured temperature based on the at least one control parameter by an illumination source.

11. The method of claim 10, further comprising determining the selected color based on a look-up table and the first parameter by the controller circuitry.

12. The method of claim 11, wherein the look-up table comprises a one-to-one mapping relationship between the plurality of colors and a plurality of fixed temperatures and/or temperature ranges.

13. The method of claim 10, further comprising selecting the color from the plurality of colors based on a predetermined function of the first parameter.

14. The method of claim 10, wherein the illumination source is installed on an extrusion assembly and moves with the extrusion assembly during the 3-D printing process.

15. The method of claim 10, wherein the illumination source is installed on a stationary object of the 3-D printer.

16. The method of claim 10, wherein the illumination source can be retrofit to the 3-D printer by connecting the illumination source with the temperature sensor via an electronic circuitry.

17. The method of claim 10, wherein the illumination source includes at least three LEDs configured to emit light of one or more colors, and the selected color corresponds to an overall output color of the LEDs.

18. The method of claim 10, further comprising converting a temperature-dependent parameter generated by the temperature sensor into the first parameter by a signal-conditioning circuitry.

19. A 3-D printing system comprising:
an extrusion nozzle for extruding at least one printing material;
a temperature sensor that measures the temperature of the extrusion nozzle and generates a first parameter indicative of the measured temperature;
a controller circuitry that selects a color representing the measured temperature from a plurality of colors and transmits at least one control parameter based on the selected color, wherein each of the plurality of colors represents a fixed range of temperatures; and
an illumination source configured to emit light of the selected color indicative of the measured temperature based on the at least one control parameter.
